(19) United States
(12) Patent Application Publication
(10) Pub. No.: US 2006/0215169 A1
(43) Pub. Date: Sep. 28, 2006

(54) Delaying interferometer

(76) Inventor: Hansjoerg Haisch, Altdorf (DE)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 10/518,161

(22) PCT Filed: Jul. 11, 2002
(86) PCT No.: PCT/EP02/07726

§ 371 Date: Mar. 24, 2006

(51) Int. Cl. G01B 9/02

(52) U.S. Cl. 356/477

(57) ABSTRACT

A method of manipulating an optical signal includes a) splitting the optical signal into a first signal and a second signal, b) using the second signal as a signal undelayed with respect to the optical signal, c) delaying the first signal with respect to the second signal, d) splitting the first signal into a first and a second part, e) using the second part of the first signal as a delayed signal, and f) repeating steps a)-d) with the first part of the first signal.

### BACKGROUND OF THE INVENTION

The present invention relates to manipulating an optical signal, in particular to manipulating an optical signal in an optical interferometer, more particular to manipulating an optical signal in a swept wavelength interferometer having a measurement arm for a device under test (DUT) and a reference arm.

### SUMMARY OF THE INVENTION

Therefore, it is an object of the invention to provide improved manipulation of an optical signal. The object is solved by the independent claims.

An advantage of an embodiment of the present invention is that the following problem of prior art interferometers can be avoided: A DUT in the measurement arm of an interferometer has a certain group delay. The reference arm has a certain group delay, also. However, the group delay of the DUT is normally bigger than that of the reference arm. Therefore, when sweeping the frequency of a tunable laser source (TLS), which is feeding the interferometer with a laser beam, a signal with a certain frequency having traveled through the measurement arm is arriving later at the detector than the signal of the reference arm with that frequency. Consequently, the signal of the DUT interferes with a reference signal having a different frequency not being the reference frequency belonging to the detected DUT signal.

In an embodiment of the present invention, by introducing a delay line, preferably by introducing a loop, in the reference arm of the interferometer it is possible to achieve two targets at the same time: First, it is created a wavelength reference unit (WRU) for the TLS and, second, it is generated a periodic delay line in the reference arm that allows to match the delay of the reference arm to a delay in the measurement arm caused by the DUT. The first is possible because the beat signal frequency of the interference signal between the delayed part and the non-delayed part of the signal is determined by the frequency sweep rate of the TLS. Therefore, the beat signal frequency is a direct measure of the tuning speed of the TLS. The present application seeks independent protection for this aspect, also.

Furthermore, when combining the signals of the DUT arm and of the reference arm the beat signal frequency of the interference signal is determined by the frequency sweep rate of the TLS and by the group delay difference between the DUT and the reference arm. This means that at the end of the interferometer a detector can detect two beat frequencies, which however can be separately processed to evaluate a wavelength reference and a measurement result. Advantageously, only one detector for both beat frequencies is necessary.

Especially when analyzing DUTs with big group delays the afore mentioned situation becomes a serious problem since the beat signal frequency might become larger than the interferometer detection bandwidth.

Due to the delay line or loop integrated in the reference arm of the inventive interferometer there is introduced a delay in at least a part of the reference signal. Then at least a part of the delayed part is delayed again and so on. This provides for every possible delay of the DUT a suiting delayed signal in the reference signal. This means, also for a certain limited bandwidth of a photo diode used as a part of a detector measuring the interference signal it will nearly always be possible to detect a beat frequency. Therefore, no variable time delay compensation is necessary.

Possible application fields of embodiments of the present invention are measurement setups for loss and phase characterization of long devices or DUTs having large group delay.

Another advantage of an embodiment of the present invention is that the delay line or integrated WRU also can be used to compensate for nonlinearities in the sweeping velocity of the TLS. The present application seeks independent protection for this aspect, also.

Additionally, embodiments of the present invention can reduce the impact of the laser phase noise on the measurement.

Moreover, embodiments of the present invention can reduce laser phase noise induced de-correlation of the signals in an interferometer.

In a preferred embodiment of the invention the delay line comprises at least one beam splitter or coupler connected to a loop providing the delay. The percentage of the beam coupled out by the coupler can be determined individually, i.e. any percentage can be used for the present invention, e.g. 95:5, 90:10, 80:20, 70:30, 50:50, 30:70, 20:80, 10:90, 5:95 etc.

In another preferred embodiment of the invention the delay line, preferably comprising a loop, is connected by two beam splitters or couplers with the line providing the signal, one coupler for coupling in the signal and one coupler for coupling out the signal. This allows optimizing independently the amount of power that is coupled into the delay line and out of the delay line.

In another preferred embodiment of the invention the inventive delay line is used to provide comb like frequency lines in a certain frequency range.

A further advantage of embodiments of the present invention is a reduced setup group delay impact on measurement results.

Other preferred embodiments are shown by the dependent claims.

It is clear that the invention can be partly embodied or supported by one or more suitable software programs, which can be stored on or otherwise provided by any kind of data carrier, and which might be executed in or by any suitable data processing unit.

### BRIEF DESCRIPTION OF THE DRAWINGS

Other objects and many of the attendant advantages of the present invention will be readily appreciated and become better understood by reference to the following detailed description when considering in connection with the accompanied drawings. The components in the drawings are not necessarily to scale, emphasis instead being placed upon clearly illustrating the principles of the present invention. Features that are substantially or functionally equal or similar will be referred to with the same reference sign(s).

FIG. 1 shows a schematic illustration of a fiber delay line WRU according to an embodiment of the present invention;

FIG. 2 shows a schematic illustration of an integrated delay line interferometer according to an embodiment of the present invention;

FIG. 3 shows a schematic illustration of an integrated delay line interferometer according to an embodiment of the present invention; and

FIG. 4 shows a schematic illustration of a fiber delay line WRU using split coupling for improved power distribution according to an embodiment of the present invention.

### DETAILED DESCRIPTION OF THE INVENTION

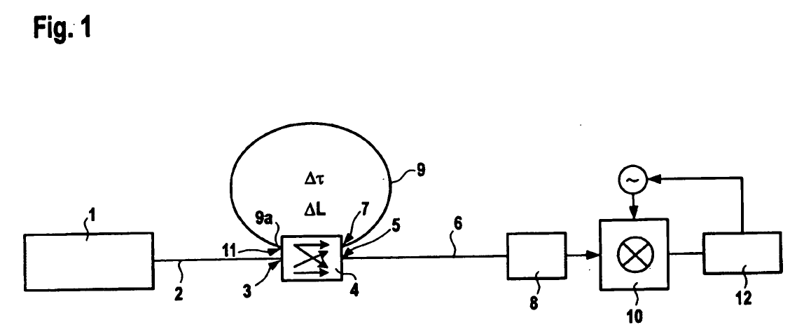

Referring now in greater detail to the drawings, FIG. 1 shows a schematic illustration of a fiber delay line WRU according to an embodiment of the present invention. A TLS 1 provides a laser beam to a fiber 2. The fiber 2 is connected to a first port 3 of a fiber coupler 4. Connected to a second port 5 of the fiber coupler 4 is another fiber 6 connected to a detector 8 comprising a not shown photo diode. Connected to the detector is a mixer 10 that is connected to a WRU processing unit 12.

The fiber coupler 4 provides 50% of the incoming power at port 3 to outgoing port 5 and 50% to another outgoing port 7 as indicated by arrows in the box of fiber coupler 4 in FIG. 1. Port 7 is connected to a fiber delay line 9 with a length of ÄL providing a delay of Äτ as indicated by respective symbols in FIG. 1. An end 9a of a delay line 9 in form of a loop is connected to a second ingoing port 11 of the fiber coupler 4. The power received by port 11 is divided at a ratio of 50:50 to the outgoing ports 5 and 7 as indicated by arrows in the box of fiber coupler 4 in FIG. 1.

The inventive method works as follows: When continuously tuning the TLS 1 it is generated a light wave with increasing optical frequency in fiber 2. 50% of this signal is coupled into delay line 9 and 50% travels undelayed into fibers 6. Since the delayed signal is coupled into fiber 6 by coupler 4, also, detector 8 detects two signals having different optical frequencies f1 and f2. The frequency difference between f1 and f2 is determined by the product of the tuning rate γ of the TLS 1 and the signal delay. These signals interfere at detector 8 and generate a beat signal of frequency f1-f2, thus the frequency of which is a direct measure of the tuning rate of the TLS 1. Since part of the delayed signal is again coupled into the delay line 9 the delay can be written as follows: n*Äτ, n being the number of circulations of the signal in the delay line 9.

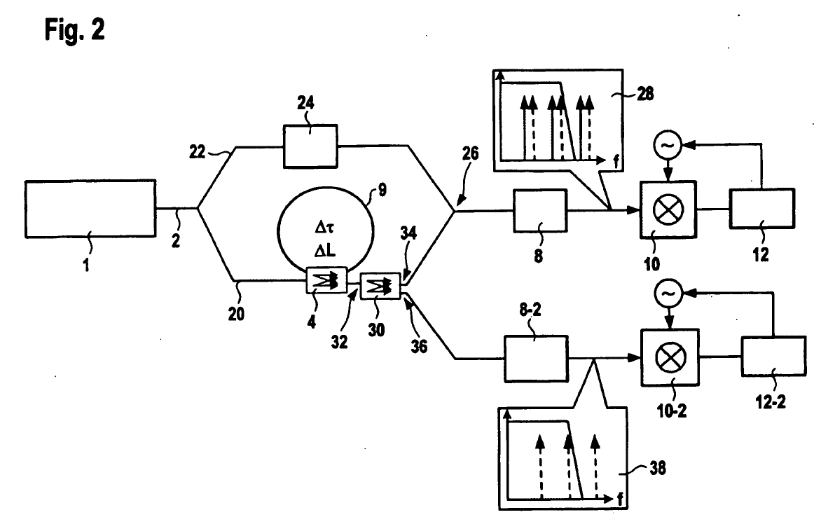

FIG. 2 shows a schematic illustration of an integrated delay line interferometer according to an embodiment of the present invention. The interferometer comprises a reference arm 20 and a measurement arm 22. In the reference arm 20 a delay line 9 according to FIG. 1 is coupled in by a coupler 4. In the measurement arm 22 a DUT 24 is connected. Reference arm 20 and measurement arm 22 are superimposed by a not shown beam splitter at 26. The signals of the reference arm 20 and the measurement arm 22 interfere at 26 and are detected by a detector 8. The resulting beat frequencies as indicated by a schematic graph 28 are provided to a mixer 10 and a DUT processing unit 12.

Additionally to coupler 4 another coupler 30 is coupled into the reference arm 20 after the coupler 4. Coupler 30 has an incoming port 32 and two outgoing ports 34 and 36. Outgoing port 34 is connected to the recombining beam splitter at 26 whereas outgoing port 36 is connected to a second detector 8-2 which is connected to a second mixer 10-2 that is connected to a WRU processing unit 12-2. Detector 8-2 detects beat. Second detector 8-2 detects the WRU information whereas detector 8 detects both WRU and DUT information. With the help of detector 8-2 it is possible to evaluate the WRU information unambiguously.

Due to the delay line 9 the interferometer beat frequencies are nearly independent of a length of the DUT 24. E.g. without the delay line 9 and if the sweeping velocity would be approximately 40 nm/s and the length of the DUT 24 would be up to 100 m the beat frequency of the interferometer would oscillate between 0 and approximately 2.5 MHz. However, if a delay line 9 is introduced with a length of approximately 10 m the beat frequency of the interferometer would oscillate between 0 and approximately 0.250 MHz, only.

Detector 8 and detector 8-2 both detect beat signals N*Äτ*γ as auto beat signals with frequencies as illustrated in schematic graph 38 and detector 8 detects signals (τ1−τ2−N*Äτ)*γ with frequencies as illustrated in schematic graph 28 as a measurement beat signal. Within the detector bandwidth of detector 8 as indicated by the solid line in schematic graph 28 it is possible to select one or two auto beat signals as indicated by arrows in the schematic graph 28 by means of the processing units 12 and 12-2.

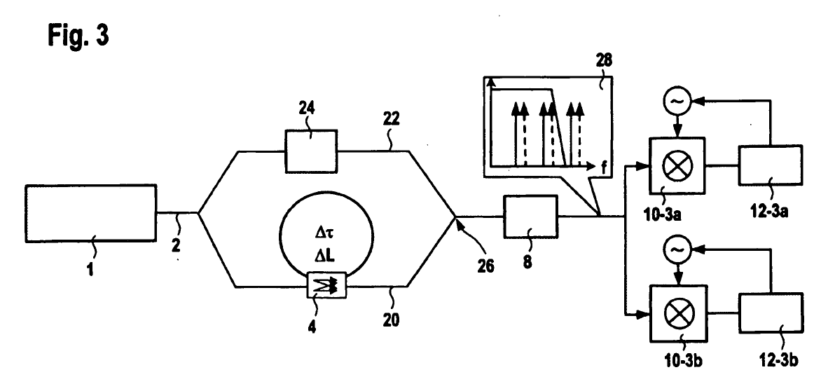

FIG. 3 shows a schematic illustration of an integrated delay line interferometer according to an embodiment of the present invention. The difference of the embodiment of FIG. 3 to the embodiment of FIG. 2 is that there is no additional coupler 30 provided in the reference arm 20 of the interferometer. However, detector 8 is connected to two mixers 10-3a and 10-3b that are each connected to a processing unit 12-3a and 12-3b. Processing unit 12-3a is a WRU processing unit according to the WRU processing unit 12-2 of the embodiment of FIG. 2 whereas the processing 12-3b is a DUT processing unit according to the DUT processing unit 12 of the embodiment of FIG. 2.

Detector 8 detects beat signals N*Äτ*γ as an auto beat signal and detects (τ1−τ2−N*Äτ)*γ as a measurement beat signal. Within the detector bandwidth of detector 8 as indicated by the solid line in schematic graph 28 it is possible to select one or two auto beat signals as indicated by arrows in the schematic graph 28 by means of the processing units 12-3a and 12-3b.

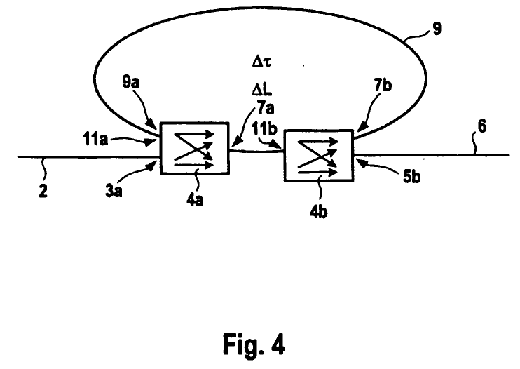

FIG. 4 shows a schematic illustration of a fiber delay line WRU using split coupling for improved power distribution between the power coupled back into the delay line 9 and from the delay line to fiber 6 according to an embodiment of the present invention. This embodiment can be used in all above described embodiment of FIG. 1-3. According to the embodiment of FIG. 4 coupler 4 is split into two couplers 4a and 4b. Only port 7a of first coupler 4a is connected to an incoming port 11b of second coupler 4b. Outgoing ports 5b and 7b of second coupler 4b have the same function as outgoing ports 5 and 7 of coupler 4 in FIG. 1, i.e. outgoing port 7b is connected to the fiber delay line 9 which is connected with its end 9a to incoming port 11a of first coupler 4a. Incoming port 3a of coupler 4a is connected to fiber 2 and outgoing port 5b of second coupler 4b is connected to fiber 6.

What is claimed is:

1. A method of manipulating an optical signal, comprising the steps of:
a) splitting the optical signal into a first signal and a second signal,
b) using the second signal as a signal undelayed with respect to the optical signal,
c) delaying the first signal with respect to the second signal,
d) splitting the first signal into a first and a second part,
e) using the second part of the first signal as a delayed signal, and
f) repeating steps a)-d) with the first part of the first signal.

2. The method of claim 1, further comprising the steps of:
delaying the first signal by letting the first signal travel a different path than the second signal.

3. The method of claim 1, further comprising the steps of:
the ratio of the first and the second part ranging between 5:95 and 50:50.

4. The method of claim 1, further comprising performing all splitting operations at the same splitting point.

5. A method of determination of properties of an optical device under test, comprising the steps of:
splitting an initial light beam into a measurement beam and a reference beam of an interferometer,
coupling the measurement beam into the optical device under test,
letting the reference beam travel a different path as the measurement beam by manipulating the reference beam according to the method of claim 1,
superimposing the reference beam and the measurement beam to produce interference in a resulting superimposed light beam,
detecting the power of the resulting superimposed light beam as a function of frequency when tuning the frequency of the initial light beam from a minimum to a maximum of a given frequency range,
deriving optical properties of the device under test from the frequency dependency of the detected powers.

6. A software program or product stored on a data carrier, for executing the method of one of claim 1, when run on a data processing system such as a computer.

7. An apparatus for manipulating an optical signal, comprising:
a first splitting device for splitting the optical signal into a first signal and a second signal,
a delaying device for delaying the first signal with respect to the second signal so that the second signal can be used as a signal undelayed with respect to the optical signal,
a second splitting device for splitting the first signal into a first and a second part, so that the second part of the first signal can be used as a delayed signal, and
a repeating device for providing the first part of the first signal to the first splitting device.

8. The apparatus of claim 7, wherein the first and the second splitting devices are identical.

9. The apparatus of claim 7, wherein the splitting devices comprise a beam splitter or coupler.

10. The apparatus of claim 7, wherein the delaying device is a loop connected with the splitting devices.

11. The apparatus of claim 7, wherein the delaying device and the repeating device are identical.

12. An apparatus for determination of properties of an optical device under test, comprising:
a first beam splitter for splitting an initial light beam into a measurement beam and a reference beam of an interferometer,
a connecting device for coupling the measurement beam into the optical device under test,
an apparatus for manipulating an optical signal according to claim 7 for letting the reference beam travel a different path as the measurement beam,
a second beam splitter for superimposing the reference beam and the measurement beam to produce interference in a resulting superimposed light beam,
a detector for detecting the power of the resulting superimposed light beam as a function of frequency when tuning the frequency of the initial light beam from a minimum to a maximum of a given frequency range,
a processing unit for deriving optical properties of the device under test from the frequency dependency of the detected powers.
